(19) United States
(12) Patent Application Publication
(10) Pub. No.: US 2024/0198363 A1
(43) Pub. Date: Jun. 20, 2024

(54) ADJUSTABLE NOZZLE

(71) Applicants: Sunny Sethi, Castro Valley, CA (US); Nicholas James McKibben, Oakland, CA (US); Grant Harrison Friesen, Concord, CA (US); Sagar Bhatia, Fremont, CA (US)

(72) Inventors: Sunny Sethi, Castro Valley, CA (US); Nicholas James McKibben, Oakland, CA (US); Grant Harrison Friesen, Concord, CA (US); Sagar Bhatia, Fremont, CA (US)

(73) Assignee: HEN NOZZLES INC., Hayward, CA (US)

(21) Appl. No.: 18/390,659

(22) Filed: Dec. 20, 2023

Related U.S. Application Data
(60) Provisional application No. 63/542,340, filed on Oct. 4, 2023.
(60) Provisional application No. 63/433,892, filed on Dec. 20, 2022.

(51) Int. Cl. B05B 1/12; A62C 31/03; B05B 1/04

(52) U.S. Cl. CPC B05B 1/12; A62C 31/03; B05B 1/044

(57) ABSTRACT

A nozzle including a nozzle body having a flow path therein, the nozzle further including a face plate coupled to or positioned in the nozzle body and having an engagement surface. The nozzle includes an arm coupled to or positioned in the nozzle body, the arm including an engagement surface engaging the engagement surface of the face plate. At least one of the engagement surface of the face plate or the engagement surface of the arm has at least part of a spherical surface. The face plate and the arm are configured such that relative rotation between the face plate and the nozzle body causes at least part of the arm to move toward or away from a center of the flow path.

This invention was made with government support under Contract No. 2127461 awarded by The National Science Foundation. The government has certain rights in the invention.

This application claims priority to U.S. provisional patent application Ser. No. 63/433,892 filed on Dec. 20, 2022 entitled Smooth Bore Nozzle, and U.S. provisional patent application Ser. No. 63/542,340 filed on Oct. 4, 2023 entitled Smooth Bore Nozzle. The entire contents of both of those applications are incorporated by reference herein.

The present invention relates to a nozzle configured to spray fluids, and more particularly to a nozzle configured to spray pressurized fluids.

### BACKGROUND

Nozzles are typically configured to be coupled to a fluid source so that the fluid flows through and exits the nozzle. The nozzle can be configured to affect the size, shape, velocity and/or other characteristics the fluid flowing therethrough. In some cases, the nozzle can include a movable arm to vary the properties of the exiting fluid. In addition, fluid flow within the nozzle is often desired to be laminar in nature to the extent possible to optimize fluid flow and provide a more predictable spray pattern. Such nozzles can require precision in the manufacturing and assembly thereof.

### SUMMARY

In certain aspects the present disclosure is directed to a nozzle and a method of operation that provides precision in the manufacturing and assembly thereof, and various other features that improve the use thereof. More particularly, in one embodiment the disclosure includes a nozzle including a nozzle body having a flow path therein, the nozzle further including a face plate coupled to or positioned in the nozzle body and having an engagement surface. The nozzle includes an arm coupled to or positioned in the nozzle body, the arm including an engagement surface engaging the engagement surface of the face plate. At least one of the engagement surface of the face plate or the engagement surface of the arm has at least part of a spherical surface. The face plate and the arm are configured such that relative rotation between the face plate and the nozzle body causes at least part of the arm to move toward or away from a center of the flow path.

### BRIEF DESCRIPTION OF THE DRAWINGS

FIG. 1 is a perspective view of one embodiment of a nozzle;

FIG. 2 is an exploded perspective view of the nozzle of FIG. 1;

FIG. 3 is a detail view of the nozzle body of FIG. 2, with the nozzle body portions positioned closer together;

FIG. 4 is a cross section of the nozzle body of the nozzle of FIG. 1, taken along line 4-4;

FIG. 5 is a cross section of the nozzle body of the nozzle of FIG. 1, taken along line 5-5;

FIG. 6 is a front perspective view of the first nozzle body portion of the nozzle FIGS. 2 and 3, shown in an inverted position from that of FIGS. 2 and 3;

FIG. 7 is a longitudinal cross section of the nozzle of FIG. 1, with the arms in their retracted positions;

FIG. 8 shows the nozzle of FIG. 7, with the arms in their extended positions;

FIG. 9 is a perspective detail view of an arm of the nozzle of FIG. 1;

FIG. 10 is a perspective view of a face plate of the nozzle of FIG. 1;

FIG. 11 is a perspective view of two arms of FIG. 9 in conjunction with the face plate of FIG. 10, with the arms in their retracted positions;

FIG. 12 is a side cross section of the assembly of FIG. 11

FIG. 13 shows the assembly of the FIG. 11, with the arms in their extended positions;

FIG. 14 is a longitudinal cross section of an alternate embodiment of the nozzle, with the arms in their retracted positions;

FIG. 15 is a front perspective, partially exploded view of the nozzle of FIG. 14;

FIG. 16 is a perspective detail view of an alternative arm of the nozzle of FIG. 1;

FIG. 17 is a front perspective view of a nozzle, illustrating a range of nozzle surfaces that can sealingly engage the arms;

FIG. 18 is a front perspective view of the inner portion of an arm;

FIG. 19 shows the arm of FIG. 18 with an outer portion positioned over the inner portion;

FIG. 20 is a front perspective view of the inner portion of an arm;

FIG. 21 shows the arm of FIG. 20 with an outer portion positioned over the inner portion;

FIG. 22 is a cross section taken along line 22-22 of FIG. 21;

FIG. 23 is a front perspective view of the inner portion of an arm;

FIG. 24 shows the arm of FIG. 23 with an outer portion positioned over the inner portion;

FIG. 25 is a cross section taken along line 25-25 of FIG. 24;

FIG. 26 is a front perspective view of the inner portion of an arm;

FIG. 27 shows the arm of FIG. 26 with an outer portion positioned over the inner portion;

FIG. 28 is a cross section taken along line 28-28 of FIG. 27;

FIG. 29 is a front view of a nozzle show in conjunction with a pair of sealing sheets and a pair of arms shown in an exploded configuration;

FIG. 30 is a side view cross sectional view of the nozzle of FIG. 29 with the sealing sheets positioned in the nozzle;

FIG. 31 is a perspective view of a nozzle with an integrated shutoff valve;

FIG. 32 is an exploded perspective view of the nozzle of FIG. 31;

FIG. 33 is a longitudinal cross section of the nozzle of FIG. 31, with the valve in its open position; and

FIG. 34 is a longitudinal cross section of the nozzle of FIG. 31, with the valve in its open position.

### DETAILED DESCRIPTION

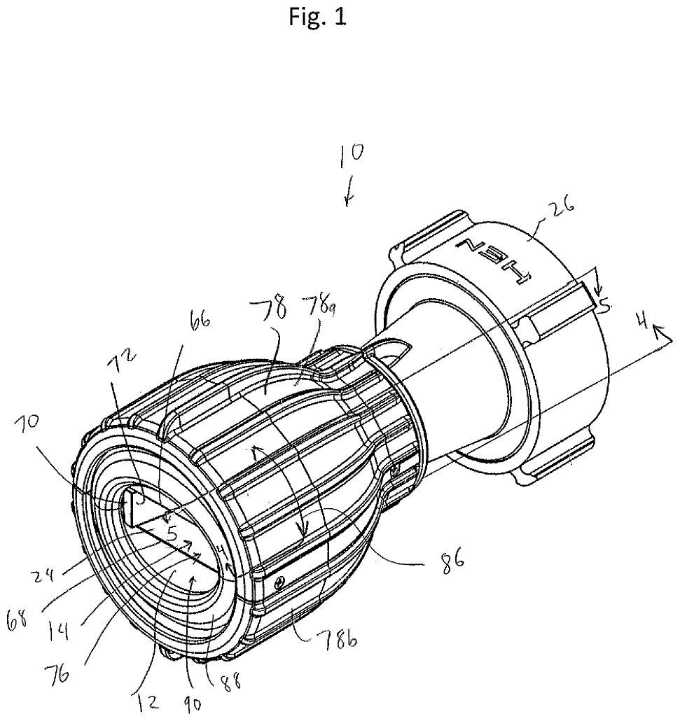

With reference to FIGS. 1-5, in one embodiment, a nozzle, generally designated 10, is configured to be coupled to a fluid source (not shown), which can provide fluid under pressure. The fluid can in one case be provided to the nozzle 10 at such pressures as are provided by a firefighting water supply, including a fire hydrant and/or fire pumper. The fluid source can thus provide water or other liquids/fluid at a pressure of, in one case, between about 100 psi and about 400 psi, or between about 100 psi and about 800 psi in another case, or greater than about 100 psi and/or less than about 400 and/or 800 psi in other cases. The nozzle 10 may be coupled to a hose, such as a firefighter handline, that itself constitutes or is in turn coupled to the fluid source.

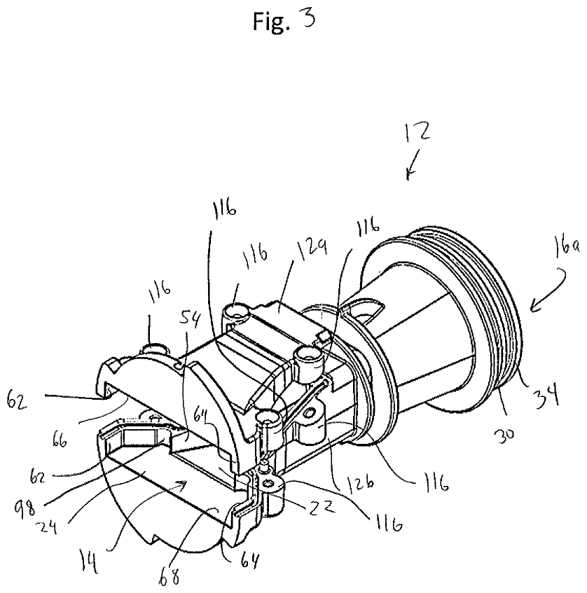

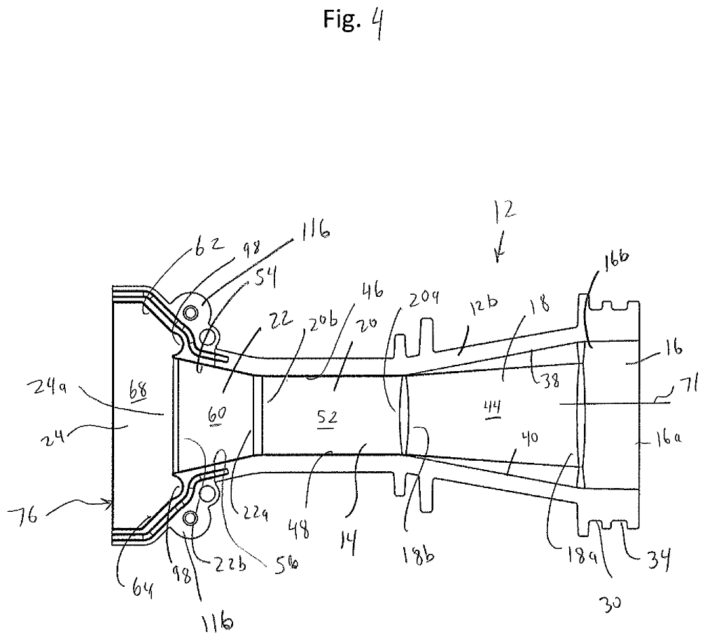

The nozzle 10 can include a nozzle body 12 including or defining therein a flow path or fluid path 14 therein through which fluid is configured to flow in a flow (downstream) direction. With reference to FIGS. 4 and 5, the nozzle 10/flow path 14 can have, generally speaking an inlet section 16, a converging section 18 positioned downstream of the inlet section 16 relative to the flow direction, a transition section 20 positioned downstream of the converging section 18, a hybrid section 22 positioned downstream of the transition section 20, and a flow modulation section 24 (also termed a modulation section) positioned downstream of the hybrid section 22. However, it should be understood that the nozzle 10/flow path 14 may not include any one, or multiple ones, of the inlet section 16, converging section 18, transition section 20 and/or hybrid section 22. Thus the nozzle 10/flow path 14 may include, in one case, only an inlet section 16 and modulation section 24, or an inlet section 16 and modulation section 24 with any one, or any two, or all, of the converging section 18, transition section 20 or hybrid section 22. The nozzle 10 can also include other or additional sections or the like not shown or described herein.

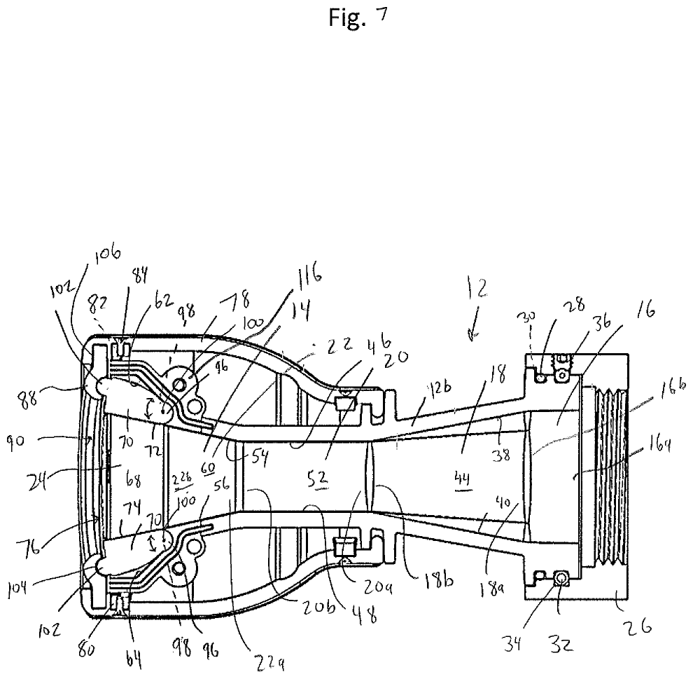

The inlet section 16 is, in one case, generally cylindrical and/or generally circular in cross section, particularly at an inlet 16a of the inlet section 16. In one embodiment the inlet section 16 includes or is coupled to fitting 26 (FIGS. 1, 2, 7 and 8). In the illustrated embodiment the fitting 26 takes the form of a threaded swivel adaptor configured to attach the nozzle 10 to an outer threaded surface of the fluid source such as a hose, landline or the like. The fitting 26 can be secured to the nozzle 10 by a retaining ring 28 (FIGS. 7 and 8) that is received in an annular recess 30 of the nozzle body 12. A series of balls 32 may be received in another annular recess 34 of the nozzle body 12, and trapped by a threaded plug 36, to facilitate relative rotation between the fitting 26 and the nozzle body 12. Alternatively an inner or outer threaded surface, or other surface or component, configured to be coupled to the fluid source (e.g. hose, in one case) can be provided and/or be integrally formed in or on the nozzle 10/inlet section 16.

The inlet section 16 can have a circular shape at its inlet 16a and also at its outlet 16b, as shown in the illustrated embodiment. In other cases, the inlet section 16 can transition, or begin to transition, along the flow path 14/flow direction, from a circular cross-sectional shape at the inlet 16a (or 18a), to a rectangular or generally rectangular cross-sectional shape at an outlet 16b (or 18b). It should be noted the rectangular or generally rectangular shape at the outlet 16b of the inlet section 16, if implemented, can include radiused/rounded corners, which can help to avoid stress concentrations and/or provide ease of manufacture. It should also be noted that this quality with respect to the radiused/rounded corners can apply to any cross sectional shape of the nozzle 10/flow path 14 that is described herein as being rectangular or generally rectangular.

The transition from the circular to rectangular cross-section (which can in one case occurs in the inlet section 16, but in the illustrated embodiment occurs in the converging section 18) can be configured such that an angle of transition θ (in one, two or multiple planes) can be between 5° to 30°. The angle of transition θ can be represented or visualized by an angle drawn from the outer perimeter of a circle at the inlet 16a/18a and a rectangle at the outlet 16b/18a, and visible in FIGS. 4 and 5 in the context of the converging section 18, defined by walls 38, 40, 42 and/or 44. If the inlet 16a/18a has a circular cross section with diameter D and the outlet 16b/18b has a rectangular cross section with sides a and b (where a>b), the length Lᵢₙₗₑₜ of the inlet section 16 (or the length L_{converging} of the converging section 18) can be such that length Lᵢₙₗₑₜ or L_{converging} is the longer of the two following equations: (D−a)/2 tan θ or (D−b)/2 tan θ, where in one case the value of the θ is between 5° to 30°.

The converging section 18, if utilized, can in one case transition along the flow path 14/flow direction, from a shape at its inlet 18a, corresponding to the outlet 16b of the inlet section 16 (e.g., circular, rectangular, or a hybrid/transitional shape in cross section), to in one case, a generally rectangular cross sectional shape at an outlet 18b thereof. In one case, the converging section 18 can transition along the flow path 14/flow direction, from a circular cross-sectional shape at the inlet 18a, to a rectangular or generally rectangular cross-sectional shape at an outlet 18b of the converging section 18. In the case where the converging section 18 (and not the inlet section 16) transitions from a circular cross section to a rectangular cross section, then a length of the converging section L_{converging} can be determined based upon the equations above.

The converging section 18 can converge in cross sectional area along its length such that a cross sectional area at the outlet 18b of the converging section 18 is less than a cross sectional area at the inlet 18a of the converging section 18. The converging section 18 can also converge in its perimeter along its length such that a perimeter at the outlet 18b of the converging section 18 is less than a perimeter at the inlet 18a of the converging section 18. The perimeter of a portion of the converging section 18 (or other sections) can be considered or measured as the length extending around the inner/wetted surface of the flow path 14 at that location; e.g. in the case of a rectangular cross-sectional shape, a total of the length of all four sides of the rectangle. Thus perimeter can be considered the same as or analogous to surface area (in one case, surface area with a thickness limit approaching zero) at that particular location.

In an alternative embodiment, the converging section 18 can also diverge in its perimeter along its length such that a perimeter at the outlet 18b of the converging section 18 is greater than a perimeter at the inlet 18a of the converging section 18. In yet another alternative embodiment, the perimeter of the converging section 18 remains constant or generally constant along its length such that a perimeter at the outlet 18b of the converging section 18 is the same or generally the same as a perimeter at the inlet 18a of the converging section 18.

In one case the cross sectional area and/or perimeter of the converging section 18 decreases continuously, and in one embodiment linearly continuously, along the length of the converging section 18 along the flow path 14/flow direction. If the perimeter of the converging section 18 increases, in one case the perimeter of the converging section 18 can increase continuously, and in one embodiment linearly continuously, along the length of the converging section 18 along the flow path 14/flow direction. The converging section 18 can thereby be utilized in one case to increase the velocity (while decreasing pressure) of the fluid flowing therethrough, or vice versa.

In one case, when the converging section 18 has a rectangular cross section, the converging section has first 38 and second 40 smooth, planar opposing converging section side walls (FIG. 4), contiguous with smooth, planar opposing converging section top 42 and bottom 44 walls (FIG. 5). Each side wall 38, 40 can be oriented perpendicular or generally perpendicular to the adjacent top 42 and bottom 44 walls. In one case, one or both of the converging section side walls 38, 40 converge in the flow direction relative to each other, and one or both the converging section top 42 and bottom 44 walls converge in the flow direction relative to each other. However, if desired, in one case one or both of the converging section side walls 38, 40 diverge relative to each other in the flow direction and/or one or both of the converging section top 42 or bottom 44 walls diverge relative to each other in the flow direction.

However, even if some walls diverge while others converge in the converging section 18, in one case the cross sectional area of the converging section 18 decreases in the flow direction. Thus the converging section 18/flow path 14 can simultaneously converge in one direction while diverging in the other direction, where, in one case, the first and second directions are perpendicular or generally perpendicular. In yet another case, the converging section 18 does not change in cross sectional area along its length, and thus in certain cases the cross sectional area may remain constant or increase, or in another case remain constant or decrease, along the flow direction.

If the cross-sectional area between the inlet 18a and the outlet 18b is reduced too fast, this can lead to turbulence in the flow. Thus to minimize the turbulence, the rate of reduction of the cross-sectional area should be such that the rate of reduction is less than 45 degrees. The “rate of reduction” of the cross-sectional area can be calculated based upon the longest dimension at the inlet 18a of the converging section 18, the smallest dimension at the outlet 18b of the converging section 18 and the total length L_{converging} of the converging section 18. For example in one case the inlet 18a of the converging section 18 is a circle with diameter D and the outlet 18b of the converging section 18 is a rectangle with sides a and b, where a>b. In this case the converging section 18 can have a convergence angle α analogous to the angle θ described above. The converging section 18 can be configured such that angle α is meets the following equation: tan α=(D−b)/2L_{converging}, where value of the α is such that it is <450.

While cross sectional area should not be reduced too fast along the flow direction, on the other hand, when the angle α is too small, for example when α<50, the length of converging section 18 may increase too much, adding to the cost and weight of the nozzle 10. A balance between minimizing the turbulence and limiting the length of the converging section 18 can be achieved such that in one case the value of a is greater than 10° in one case, or less than 30° in another case, or between about 10° and about 30° in yet another case.

The outlet 18b of the converging section 18 can have a size and shape such that that flow path 14 can further converge with respect to cross sectional area in the hybrid section 22 if desired. Thus in one case the ratio of the cross sectional area of the outlet 18b of the converging section 18 and the cross sectional area of the outlet 22b of the hybrid section 22 can be represented by the value R1, where the value of R1 can be greater than 1.05, and/or less than 1.5, or in another case between about 1.05 and about 1.5.

The transition section 20, if utilized, can provide a constant, or generally constant, cross sectional area along its length. The transition section 20 can thereby reduce turbulence and/or instabilities of fluid flowing through the nozzle 10/flow path 14 as the fluid at least partially changes direction from the converging section 18 to the hybrid section 22.

In one embodiment the transition section 20 has a rectangular or generally rectangular cross sectional area and/or perimeter that remains constant, or that varies by less than about 5% in one case, or less than about 1% in another case, at any two points along the length thereof, and/or between the inlet 20a of the transition section 20 and the outlet 20b of the transition section 20. In addition, the transition section 20 can include a cross sectional area, at its inlet 20a and/or outlet 20b, that is equal to or about equal to (e.g. within about 5% in one case), the cross sectional area of the outlet 18b of the converging section 18 and/or the inlet 22a of the hybrid section 22. In one case, when the transition section 20 has a rectangular cross section, the transition section 20 can have first 46 and second 48 smooth, planar opposing parallel side walls (FIG. 4) contiguous with the converging section first 38 and second 40 side walls, respectively. The transition section 20 can in this case have smooth, planar opposing parallel top 50 and bottom 52 walls (FIG. 5), respectively, that are contiguous with the converging section top 42 and bottom 44 walls.

The transition section 20 can help reduce turbulence as the fluid changes direction from the converging section 18 to the hybrid section 22. As an example, if in the converging section 18, the walls 38, 40, 42, 44 are converging, whereas in the hybrid section 22, there are one or more walls 54, 56, 58, 60 that are diverging, at least the fluid relatively close to the walls 54, 56, 58, 60 will experience this sudden change in direction. Using computational fluid dynamic simulations, it can be observed that this sudden change in fluid velocity direction causes significant centripetal forces leading to adverse pressure gradients. Since the fluid particles closer to the walls 54, 56, 58, 60 have low velocities they are unable to overcome this adverse pressure gradient resulting in separation of flow from the boundaries. This leads to generation of local eddies and loss of kinetic energy. At such sharp transitions, these spiral motion in fluid velocity due to the local eddies can persist for downstream distances of as much as fifty times the cross-section height. This loss due to this sharp transition can be described by bend loss (B):

$$B = \frac{{KV}^{2}}{2 g}$$

In the equation above, V is the average velocity, and the value of K depends on the total length of the bend and the ratio of the curvature of the bend and the cross-section height. For a circular pipe the cross-section height is equivalent to the pipe diameter and for a square pipe the value is equivalent to the side of the square. By providing a transitional section 20 between the converging 18 and hybrid 22 sections, the impact of change in fluid direction can be reduced. The transition section 20 helps minimize the swirling motion of the local eddies and their propagation in the fluid flow. The length of the transition section 20 depends on the cross-section height and the convergence angle of the converging section 18, and divergence angles in the hybrid section 22.

Where the total change in the fluid direction between the converging 18 and hybrid 22 section is less than 30°, the length of the transition section 20 can be at least two times the cross-section height at a middle portion of the transition section 20. Where the total change in the fluid direction between the converging 18 and hybrid section 22 is more than 30° but less than 60°, the length of the transition section 20 can be at least four times the cross-section height at a middle portion of the transition section 20. Where the total change in the fluid direction between the converging 18 and hybrid section 22 is more than 60° it may be desired to have a two-step transition to mitigate local eddies associated with sudden change in fluid direction. The length of the second transition section (if utilized, not shown) can be determined by a transitional divergence angle.

The hybrid section 22, if utilized, can transition along its length along the flow path 14, from a shape and cross sectional area at its inlet 22a corresponding to an outlet 20b of the transition section 20 or other upstream section (rectangular or generally rectangular in one case), to another shape (rectangular or generally rectangular in one case) at its outlet 22b having a different cross sectional area and/or a different perimeter. The hybrid section 22 can, in one case, converge along its length with respect to cross sectional area such that a cross sectional area at the outlet 22b of the hybrid section 22 is less than a cross sectional area at an inlet 22a of the hybrid section 22. In this case the hybrid section 22 can be considered, overall, with respect to cross sectional area, a converging section. However, if desired this arrangement can be reversed such that a cross sectional area at the outlet 22b of the hybrid section 22 is greater than a cross sectional area at an inlet 22a of the hybrid section 22 such that the hybrid section 22 can be considered, overall with respect to cross sectional area, a diverging section. In yet another case, the hybrid section 22 does not change in cross sectional area along its length, and thus in certain cases the cross sectional area may remain constant or increase, or in another case remain constant or decrease, along the flow direction.

The hybrid section 22 can in one case diverge with respect to its perimeter along its length such that a perimeter at the outlet 22b of the hybrid section 22 is larger than a perimeter at the inlet 22a of the hybrid section 22. In other cases, however, the hybrid section 22 can converge in its perimeter along its length such that such that a perimeter at the outlet 22b of the hybrid section 22 is smaller than a perimeter at the inlet 22a of the hybrid section 22. The cross sectional area and/or perimeter of the hybrid section 22 can converge/diverge continuously, and in one case linearly continuously. The hybrid section 22 can thereby be utilized to increase the velocity (while decreasing pressure) of the fluid flowing therethrough, or vice versa.

Thus in one case the hybrid section 22 (and also the converging section 18) can transition from a rectangular or generally rectangular shape at its inlet to another rectangular or generally rectangular shape having a higher or lower aspect ratio, as desired. For example, if cross sectional area is desired to decrease in the flow direction while perimeter is desired to increase in the flow direction, then the flow path 14 can in one case have a rectangular cross section, with progressively greater aspect ratios, in the flow direction.

The hybrid section 22 can include smooth, planar opposing first 54 and second 56 hybrid section side walls (FIG. 4) that are contiguous with the transition section first 46 and second 48 side walls, respectively. The hybrid section 22 can also include smooth, planar opposing top 58 and bottom 60 hybrid section walls (FIG. 5) that are contiguous with the transition section top 50 and bottom 52 walls, respectively. The hybrid section side walls 54, 56 and hybrid section top 58 and bottom 60 walls can be arranged, and/or can diverge/converge, as described above in the context of the section side walls 38, 40 and section top 42 and bottom 44 walls to provide the same effects.

The hybrid section 22 can converge along the flow direction with respect to a first direction and simultaneously diverge along the flow direction with respect to a second direction. The first direction can in one case be perpendicular to the second direction, and in one case both the first and second directions are perpendicular or generally perpendicular to the flow path 14. In one case as shown in FIGS. 4 and 5, the first 54 and second 56 side walls of the hybrid section 22 diverge in the flow direction, and top 58 and bottom 60 walls of the hybrid section 22 diverge in the flow direction. In the illustrated embodiment, the rate of convergence of the top 58 and bottom 60 walls of the hybrid section 22 is greater than the rate of divergence of the first 54 and second 56 side walls of the hybrid section 22, such that the hybrid section 22, overall with respect to cross sectional area, can be considered a converging section. In one case, as outlined above, a perimeter of a cross section of the hybrid section 22 can increase along a length of the hybrid section 22 in the flow direction.

In the hybrid section 22, the fluid/successive cross sections or slices can converge in the flow direction with respect to cross-sectional area and simultaneously diverge with respect to perimeter. For a hybrid section 22 with rectangular cross section, the dimensions at the inlet 22a can be given by a1 and b1 (where a1>b1) and the dimensions at the outlet 22b can be given by a2 and b2 (where a2>b2). To simultaneously achieve convergence with respect to cross-sectional area and divergence with respect to perimeter, all of the following conditions should be satisfied: a2>a1; b2<b1 and a2×b2<a1×b1. In one case, to improve performance of the nozzle 10 the value of a2 and b2 can be such that 1.25<a2/b2<5. In one case the rate of convergence of b1 to b2 and the rate of divergence of a1 to a2 should be such that it both are less than or equal to 45°.

The flow path 14 can thus have a generally elongated shape (except possibly in the inlet section 16 and/or upstream portions of the converging section 18) having an upper surface and a lower surface. The nozzle 10 can be a smooth bore nozzle and/or the flow path 14 can be a smooth bore nozzle flow path. Thus in one case the flow path 14, and each of the inlet section 16, converging section 18, transition section 20, hybrid section 22 and modulation section 24 are smooth and unobstructed along their entire length, and for example do not include any protrusions or obstructions extending into the flow path 14 that provide a sudden change the cross sectional area. Thus in one case one or each section 16, 18, 20, 22, 24 does not have a change in cross sectional area of more than 5% along distance of less than 5% of a length of the associated section 16, 18, 20, 22, 24 and/or the nozzle 10 as a whole. In another case, there are no surfaces, bodies, obstructions or projections positioned inside the nozzle 10 or flow path 14, or any individual section 16, 18, 20, 22, 24 thereof such that the nozzle 10/sections 16, 18, 20, 22, 24 are “hollow” with nothing positioned therein and lack any blunt flow restrictions therein. Stated differently the nozzle 10 and/or each section 16, 18, 20, 22, 24 and/or each inlet or outlet thereof, and/or each portion along its length, can have an outer perimeter, and an entire inner cross sectional area defined by that outer perimeter can be open and unobstructed to allow fluid to flow therethrough.

The nozzle body 12, and any one of the inlet section 16, converging section 18, transition section 20, hybrid section 22 and modulation section 24 can be made of separate components joined together, or be a single, unitary one-piece seamless body, or combinations thereof. A cross-sectional area of the inlet section 16, converging section 18, transition section 20 and hybrid section 22, can remain constant or decrease in the flow direction of the flow path 14, along an entire length of the nozzle 10/flow path 14. The flow path 14 can be bilaterally symmetric about a centerline thereof. Other details relating to the nozzle 10 and other aspects can be found in U.S. patent application Ser. No. 17/828,087, filed on May 31, 2022 and entitled Smooth Bore Nozzle, the entire contents of which are hereby incorporated by reference.

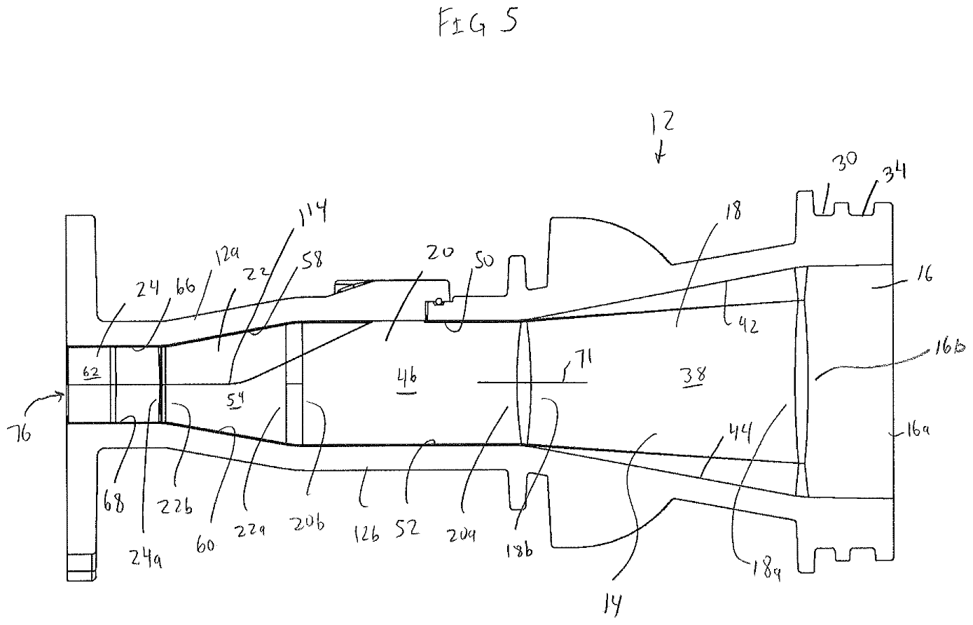

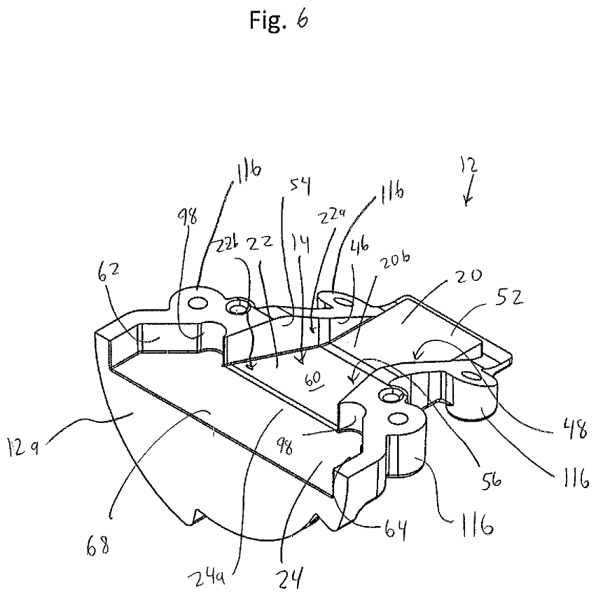

With reference to FIGS. 4-6, the modulation section 24 can include first 62 and second 64 outer walls that are contiguous with the hybrid section first 54 and second 56 side walls, respectively. The modulation section 24 can further include smooth, planar opposing top 66 and bottom walls 68 that are contiguous with the hybrid section top 58 and bottom 60 walls, respectively. The modulation section top 66 and bottom 68 walls are contiguous with modulation section outer walls 62, 64.

With reference to FIGS. 7-9, the nozzle 10/modulation section 24 can include a pair of opposed, movable arms 70 (or a first arm 70 and a second or supplemental arm 70) positioned therein, positioned on opposite sides of the nozzle 10/flow path 14 in the illustrated embodiment. The inner sides/surfaces of each arm 70 can include or define the modulation section first 72 and second side walls 74. The arms 70/side walls 72, 74 can thus extend the entire height of the modulation section 24 (i.e. the generally vertical direction of FIG. 1 and the vertical direction of FIG. 5), and thus extend entirely (or substantially entirely, to allow for manufacturing tolerances) the same height as the modulation section outer walls 62, 64 and/or the distance extending between the modulation section top 66 and bottom 68 walls. The inner surfaces/side walls 72, 74 of the arms 70 are, in the illustrated embodiment, generally flat and planar, but can have any of wide variety of other shapes, such as concave or convex shapes in certain cases.

The modulation section 24 terminates in a nozzle outlet 76. With reference to FIGS. 1, 4 and 5, the nozzle outlet 76 can be rectangular or generally rectangular in front view, defined by the side walls 72, 74 of the arms 70, and the top 66 and bottom 68 walls of the modulation section 24. The nozzle outlet 76 can be any of a variety of shapes besides rectangular, in one case oblong shapes including a rhombus, oval, ellipse or the like.

The arms 70/side walls 72, 74 of the modulation section 24 can, in one case when in their retracted positions and as shown in FIG. 7, be positioned adjacent to the outer walls 62, 64 and generally aligned with the side walls 54, 56 of the hybrid section 22 (arranged at the same angle relative to a centerline of the nozzle 10/flow path 14). However, as will be described in greater detail below, the arms 70/side walls 72, 74 can be adjustable such that the side walls 72, 74 are at a different angle relative to the centerline of the nozzle 10 than the side walls 54, 56 of the hybrid section 22, to provide a flow adjustment functionality to the nozzle 10.

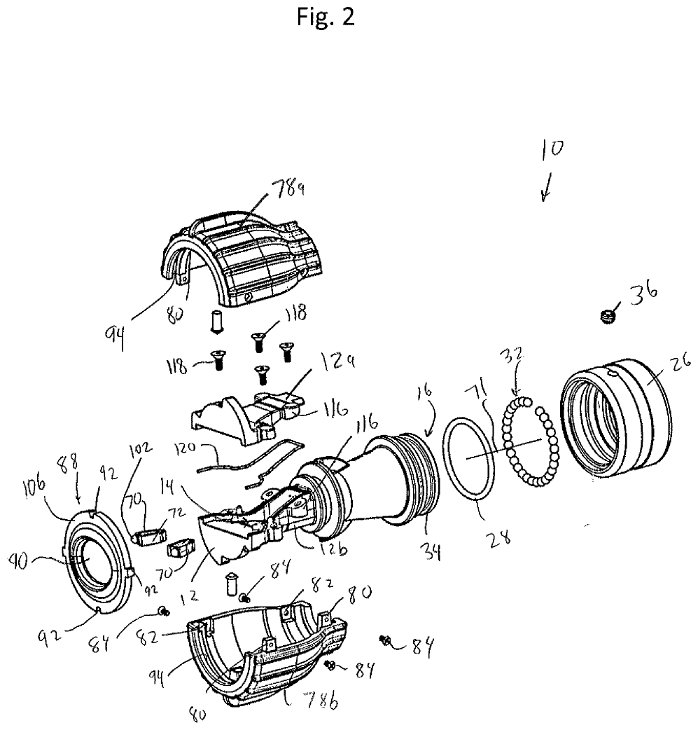

The nozzle 10 can include actuator 78 that is operatively coupled to the arms 70 to adjust an angle of the arms 70 toward and away from a center of the flow path 14, thereby varying an effective width of the variable outlet 76 to vary a pattern of fluid exiting the nozzle 10. In one embodiment, the actuator 78 includes or takes the form of shell that is rotatably mounted on and about the nozzle body 12. As shown in FIG. 2 in one case the shell 78 includes two complementary shell portions 78a, 78b (or actuator portions 78a, 78b) or shell halves that are connectable together to form the annular shell 78. Each shell portion 78a, 78b can have a pair of circumferentially extending protrusions 80 that are received in corresponding circumferentially extending recesses 82 of the other shell portion 78a, 78b, with fasteners 84 received therethrough, to secure the shell portions 78a, 78b in place.

Once assembled, the shell 78 is rotatably mounted on the nozzle body 12 and configured such that rotation of the shell 78 in the circumferential direction relative to the nozzle body 12 (see arrow 86 of FIG. 1) adjusts the position of one or both of the arms 70. In particular, as shown by the double-ended arrows of FIG. 7, the arms 70 (and their inner surfaces 72, 74) are moved/displaced by rotation of the shell 78 toward and away from the center/centerline 71 of the flow path 14 to vary the effective width of the outlet 76.

The actuator 78 can also include or take the form of a face plate 88 coupled to the shell. The face plate 88 is generally annular in one case, and has a central opening 90 through which fluid, exiting the nozzle 10, can flow. In one case, as shown in FIGS. 1 and 2 the face plate 88 is captured between the two shell portions 78a, 78b and rotatably coupled thereto such that rotation of the shell 78 also rotates the face plate 88. In particular in one case the face plate 88 includes notches and/or cutouts 92 that are received in corresponding cutouts and/or notches of the shell 78 to rotatably coupled the shell 78 and the face plate 88. The shell 78 can further include a circumferentially extending groove 94 (see FIG. 2), configured to receive the outer edge of the face plate 88 therein.

With reference to FIGS. 4, 7 and 8, a base portion 96 of each arm 70 can be movably/pivotally received in a corresponding recess 98 located in the nozzle body 12, and more particularly in or adjacent to the outer walls 62, 64 of the modulation section 24 at a junction between the hybrid section 22 and the modulation section 24 in one case. In one case the base portion 96 of each arm 70 may have a generally semicircular profile and/or shaped as a portion of a cylinder. Each recess 98 can have a corresponding semicircular shape and/or be shaped as a portion of a cylinder to closely and pivotally receive the base portion 96 therein to define a pivot point/axis 100 at the center of each cylindrical portion. In this manner each arm 70 is pivotable about an associated pivot axis 100.

Each arm 70 may include an engagement surface 102, in the form of a protrusion 102 in one case at or adjacent to a distal end thereof, protruding outwardly therefrom. Each protrusion 102 is shown as a generally hemispherical surface, but in one case can be a spherical body that includes a portion of a spherical surface.

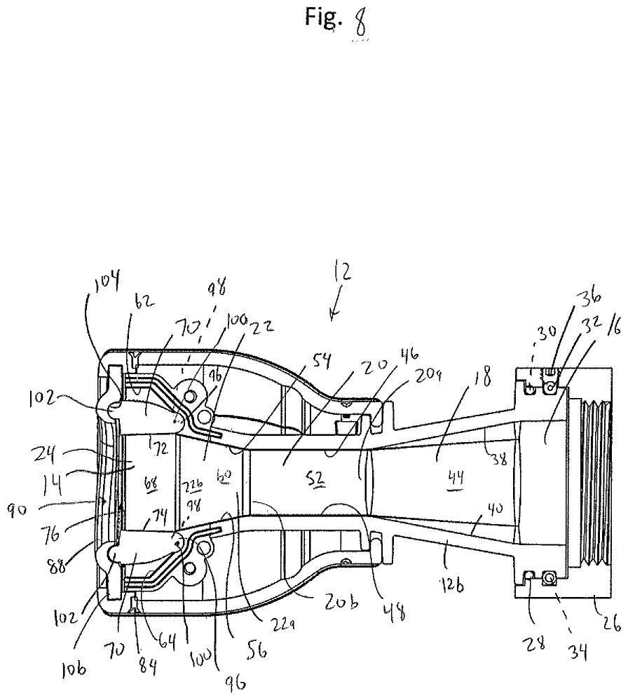

The face plate 88 includes an engagement surface 104 that extends generally around at least part of a perimeter of the face plate 88, and extends around at least part or an entirety of the flow path 14 of the nozzle 10 in end view. The engagement surface 104 in one case is a concave groove, and has at least part of a circular shape in cross section, with a radius/curvature that corresponds (in one case within 90%, an in another case within 95%, and in yet another case within 99%) to a radius/curvature of the protrusions 102 of the arms 70 to closely receive the protrusions 102 therein with no gap therebetween, as shown in FIGS. 11-13. The protrusions 102 and engagement surface/groove 104 can thus have complementary shapes.

With reference to FIG. 10, the engagement surface 104 can have a shape of or follow a path that is elliptical or generally elliptical in front view. The face plate 88 can include an generally flat, planar circumferentially extending outer face 106 positioned radially outside the engagement surface 104. In cases where the face plate 88/outer face 106 is circular or generally circular in its outer perimeter, the face plate 88 can include a filler segment 108 positioned between the outer face 106 and the engagement surface 104 to account for the different geometries of the ellipse vs. the circle. In some cases, as will be further described below, the engagement surface 104 can be recessed/out of plane relative to the outer face 106, and the filler segment 108 can thus take the form of a generally axially-extending ridge that defines a transition between the outer face 106 and the engagement surface 104.

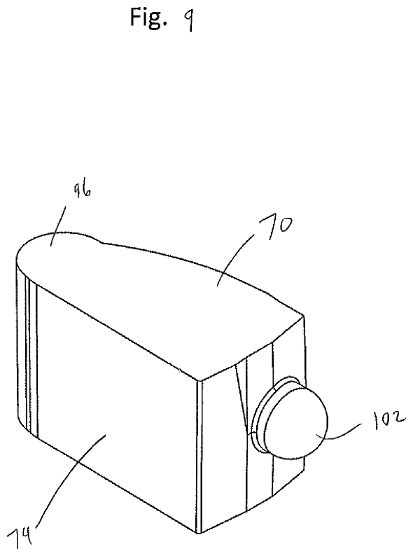

As shown in FIGS. 11-13, when the nozzle 10 is assembled the protrusion 102 of each arm 70 engages and is in contact with the engagement surface 104. Due to the rotational coupling between the shell 78 and the face plate 88, manual rotation of the actuator 78/shell 78/face plate 88 causes relative rotation and sliding motion between the engagement surface 104 and the distal end/protrusion 102 of each arm 70, which causes each arm 70 to move between an outer or retracted position (FIGS. 7 and 11) and an inner or extended position (FIGS. 8 and 13), and various intermediate positions therebetween as desired. The face plate 88 and the arms 70 are thereby configured such that relative rotation between the face plate 88 and the nozzle body 12 causes at least part of each arm 70 to move toward or away from a center 71 of the flow path 14.

In the illustrated embodiments, the arms 70 are coupled and aligned such that both arms 70 form the same angle with the center 71 of the flow path 14, at all positions thereof. The amount of angular displacement of each arm 70 (in top view, for example as shown in FIGS. 7 and 8) when moving between the retracted and extended positions, can vary, but in one case is at least about ten degrees, at least about fifteen degrees in another case, and in another case less than about eighty degrees, and in yet another case between about ten degrees and about eighty degrees. The arms 70 can be configured to be retained in position even when exposed to fluid flowing therethrough of a relatively high pressure (up to about 150 psi in one case), be accurately and uniformly rotated, and have low hysteresis to ensure repeatable and predictable positioning of the arms 70.

The elliptical or eccentric nature of the engagement surface 104 enables the arms 70 to pivot about their associated pivot points 100 in a smooth manner, when the actuator 78/shell 78/face plate 88 is rotated. In particular, when the arms 70 are in their inner or extended positions, the distal ends of the arms 70 are relatively close together and the arms 70 are thus aligned with the minor axis of the ellipse (or other eccentric surface) of the engagement surface 104. In contrast, when the arms 70 are in their outer or retracted positions, the distal ends of the arms 70 are relatively far apart and the arms 70 are thus aligned with the major axis of the ellipse (or other eccentric surface) of engagement surface 104.

When the arms 70 are in their retracted positions the distal end of the arms 70 are positioned relatively far from the centerline 71 of the flow path 14 and the arms 70 are oriented at an angle with the flow direction/centerline 71, providing a wide/diverging flow path as shown by the arrows of FIG. 11. In contrast, when the arms 70 are in their extended positions the distal ends of the arms 70 are positioned relatively close to the centerline 71 of the flow path 14 and the arms 70 are parallel or more parallel to the flow direction/centerline 71, providing a relatively narrow flow path, as shown by the arrows of FIG. 13. While the engagement surface 104 is shown as being elliptical to provide this functionality, it should be understood that the engagement surface 104 can have other eccentric (non-circular) shapes, such as ovals or the like, with relatively smooth lines/contours to avoid or minimize sticking points as the arms 70 slide about the perimeter thereof.

When the arms 70 are in the extended position, the arms 70 extend a greater distance in the axial direction/flow direction, as compared to when in the retracted position. In other words, the arms 70 have a greater effective length when in the extended position. In order to accommodate the varying effective length of the arms 70, the engagement surface 104 also has a varying dimension in the axial direction/flow direction. With reference to FIG. 7, it can be seen that the engagement surface 104 can have a curvature (or at least a local curvature) about a radius that is equal to the length of the associated arms 70 (e.g. the length from the distal end of the arm 70 to the associated pivot axis 100). This curvature of the engagement surface 104 enables the face plate 88/engagement surface 104 to accommodate the pivoting motion of the arms 70, while enabling each arm 70 to pivot about its fixed pivot point 100. In this manner, the engagement surface 104, while extending primarily in the circumferential direction, also extends somewhat in the axial direction. This provides an ellipse/eccentric surface/engagement surface 104 that extends in three dimensions, rather than being flat and essentially extending across two dimension.

Thus the pivot axis 100 for each arm 70 can be fixed, and not move relative to the arms 70 and/or nozzle body 12 during the range of movement of each arm 70 between the retracted and extended position. This fixed nature of the pivot axis 100 is enabled by providing the engagement surface 104 that extends at least partially in the axial direction, as the varying axial depth of the engagement surface 104 can thereby accommodate the longer effective length of the arms 70 when the arms 70 are in the extended positions. The fixed pivot axis 100 of each arm 70 can provide a more robust and longer-lasting pivot arrangement, and reduce leaks, compared to arrangements in which the pivot axis moves during movement of the arms 70. In addition, the circular/spherical engagement between the arms 70 and the engagement surface 104 thus allows for significant freedom of movement of the arms 70 and the engagement surface 104 and allows for a “rolling” motion of the arms 70/protrusions 102 in the engagement surface 104 to reduce binding and provide for a smoother sliding motion.

It should be understood that, if desired, the male/female aspect of engagement surface 104/arms 70 can be reversed. In this case, then the engagement surface 104 of the face plate 88 can be a protruding surface with, in one case, a generally semicircular cross section, and, the arms 70 can include an engagement surface with corresponding/complementary shape, with for example a generally hemispherical recess formed at a distal end of the arms 70 to closely engage with the engagement surface 104.

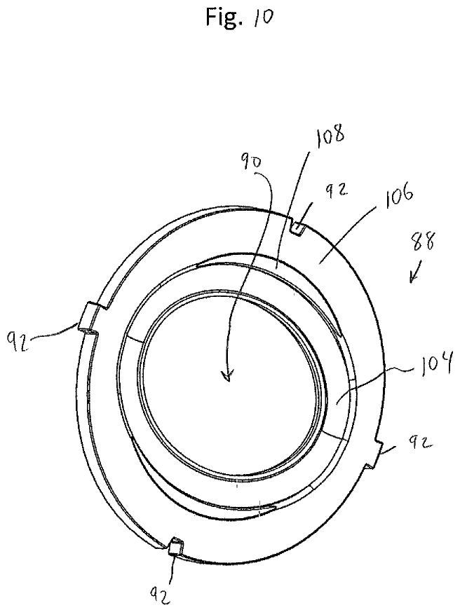

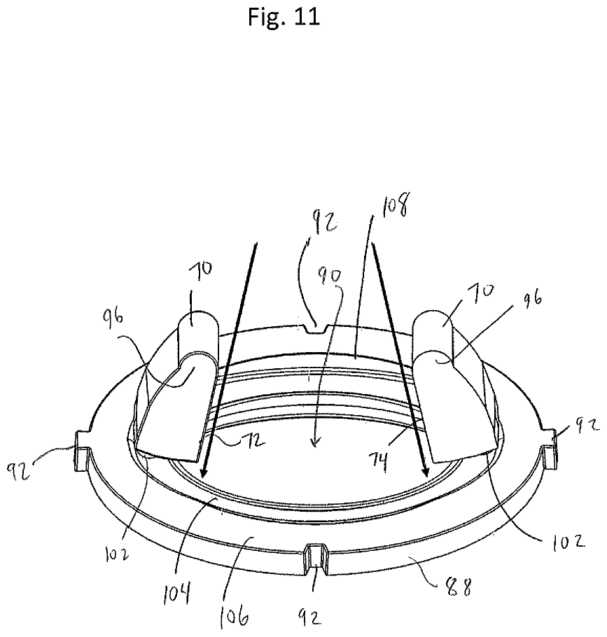

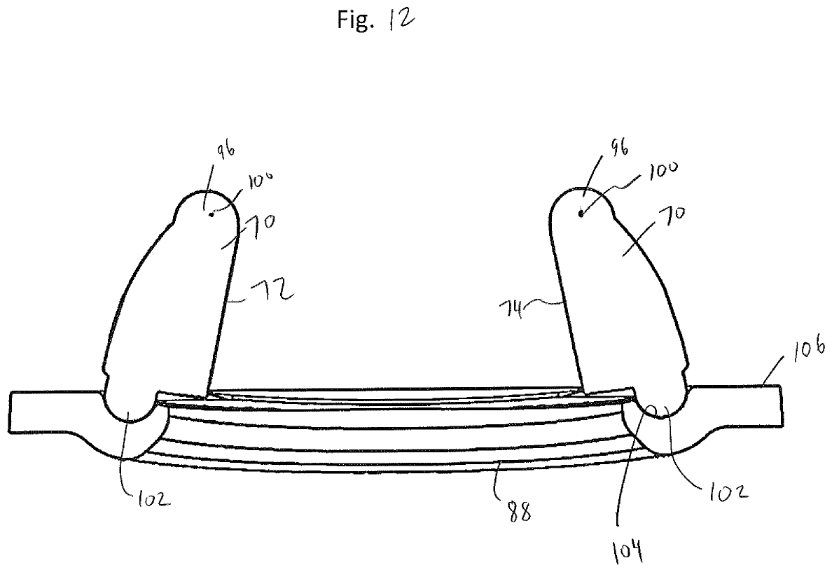

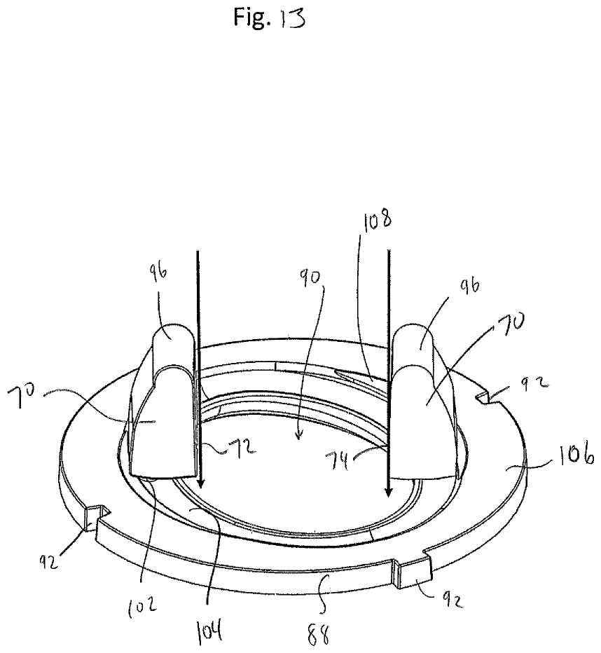

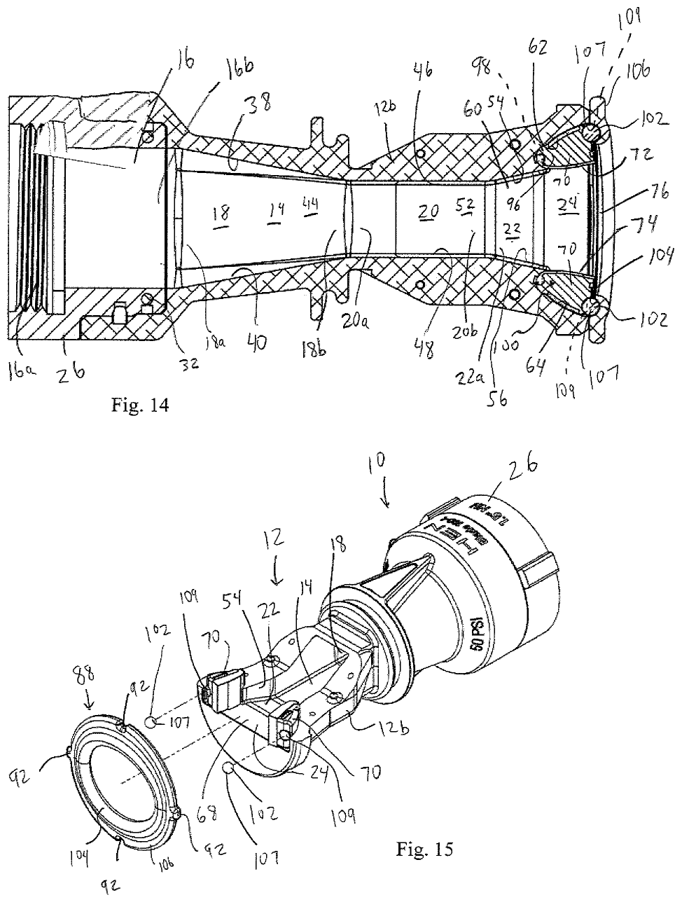

FIGS. 14 and 15 illustrate an alternative embodiment of the nozzle 10/arms 70/protrusions 102. In particular, in the embodiment of FIGS. 14 and 15 the protrusions 102 include or take the form of a ball/sphere 107 that is rotatably captured at a distal end of the associated arm 70. In particular, each arm 70 can include a spherical (e.g. partially spherical) socket 109 at the distal end thereof that closely captures the ball 107 (e.g. the socket 109 extends for greater than ½ of the surface area of a sphere) but leaves part of the ball 107 exposed such that the ball 107 is rotatable in the socket 109. The balls 107 thus provide rolling contact between the arm 70/protrusions 102 and the face plate 88 during relative rotation therebetween, and the balls 107 essentially function as ball bearings. The rolling contact, in turn, reduces friction between the protrusions 102 and the face plate 88, which provides for easier operation by the user and reduced wear and tear on the protrusions 102 and the face plate 88. It should be noted that in the alternative embodiment noted above, when the protrusions 102 are located on the face plate 88 instead of the arms 70, the protrusions 102 can also take the form of the balls 107 and shown herein.

In one embodiment, the shell 78/face plate 88 and/or nozzle body 12 may include includes stops or bosses positioned and configured to engage stops or bosses on the other one of the shell 78/face plate 88 or nozzle body 12 to limit rotation of the shell 78/face plate 88 relative to the nozzle body 12. In one case embodiment, the relative rotation of the shell 78/face plate 88 is limited to ninety degrees clockwise and counterclockwise rotation. The engagement surface 104 of the face plate 88 and the arms may be configured such that such a ninety degree rotation relative rotation of the actuator 78 causes the arms 70 to pivot from their fully retracted positions to their fully extended positions, or vice versa. However, the amount of angular rotation of the actuator 78 required to move the arms 70 their full range of motion can in one case vary between about ten degrees and about one hundred and eighty degrees.

In one case the actuator 78 and nozzle body 12 are configured to provide tactile feedback to a user when the actuator 78 is sufficiently manually rotated to cause the arms 70 to be in at least one of the retracted or extended positions. For example, one of the actuator 78 and nozzle body 12 can include a protrusion that closely fits into, or “snaps” into, a recess on the other one of the actuator 78 and nozzle body 12 when an arm 70 is in one or both of the retracted or extended positions.

As shown in FIG. 16, in one embodiment each arm 70 can include an inner portion 110 made of a relatively stiff material, and an outer portion 112 positioned on one or more, or each, side of the inner portion 110 (in the illustrated case, on either side of thickness direction of the arm 70; the vertical direction of FIG. 16). The outer portion 112 can be made of a relatively soft/pliable material (in one case having a hardness at least about 15% less in one case, or at least about 25% less in another case, or at least 35% less in yet another case, compared to the hardness of the inner portion 110 as measured by a Shore A and/or Shore D hardness scale and/or durometer measurements). For example, the inner portion 110 can be made of metal (including aluminum or stainless steel), fiberglass, composite materials, relatively hard plastic materials, etc. and the outer portions 112 can be made of elastomers, rubber, synthetic rubber, polymers, etc. The outer portions 112 can be secured to the inner portion 110 by any of a variety of methods, such as compression molding, over molding (polymer body), insert molding (metallic body), liquid silicone rubber overmolding, via the use of adhesive-backed elastomers, or otherwise. The inner portion 110 can provide stiffness and dimensional stability to the arms 70, and the outer portions 112 can provide a sealing surface with the adjacent upper 66/bottom 68 walls of the modulation section 24 and ensure the arms 70 do not bind when moving between the retracted and extended positions.

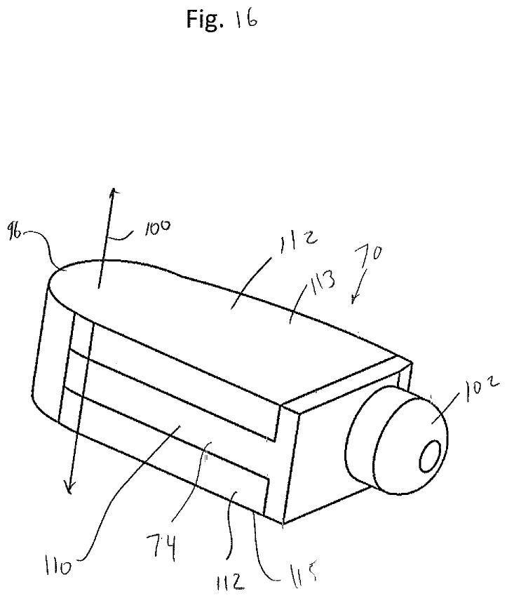

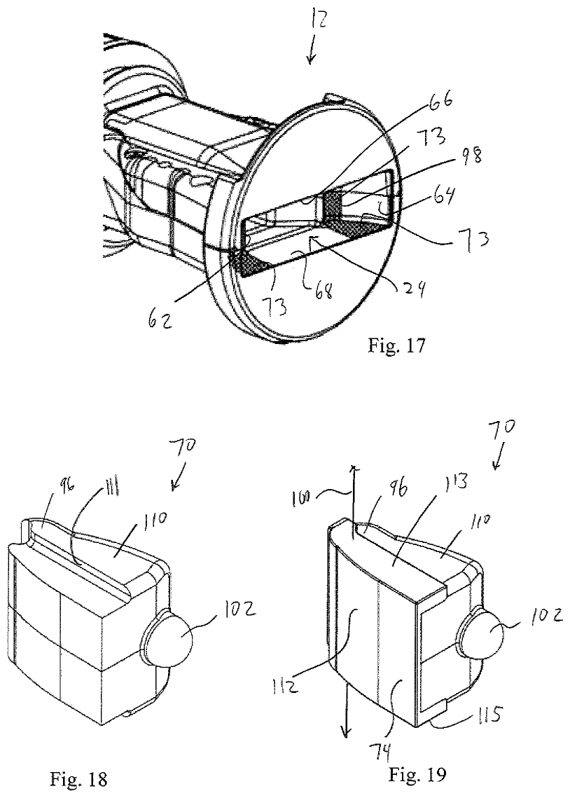

The arms 70 can be configured such that all, or an entirety, or at least about 25% in one case, or at least about 50% in another case, of the upper surfaces 113 and/or lower surfaces 115 of the arms 70 are covered with/defined by the outer portion 112 to form a sealing contact with the nozzle body 12, and more particularly with the top wall 66 and bottom wall 68 of the nozzle body 12. The arms 70 can be configured such that all, or an entirety, or at least about 75% in one case, of the base portions 96 are covered with/defined by the outer portion 112 to from a sealing contact with the nozzle body 12, and more particularly with the associated recess 98. Thus as shown in FIG. 17, the arms 70 can form sealing contact across the range of motion of the arms 70, shown as shaded surfaces 73 (it being understood that the surfaces 73 of the upper surface 113 and the other recess 98 are not visible in FIG. 17)

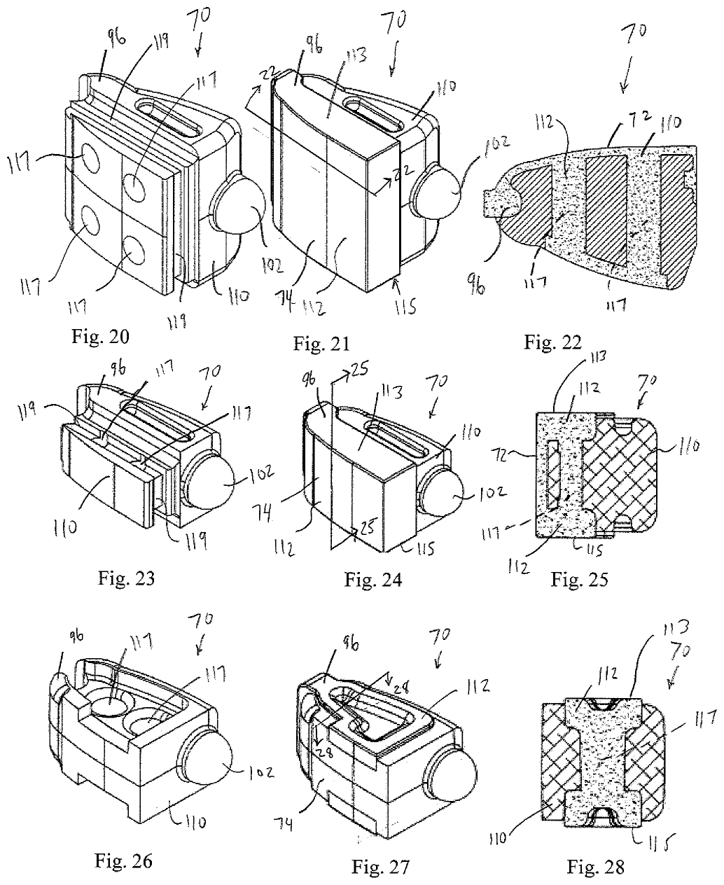

FIG. 18 shows an embodiment of an inner portion 110 of an arm 70 without the outer portion 112 positioned thereon, and FIG. 19 shows the arm 70 of FIG. 18 with the outer portion 112 thereon. In that embodiment the inner portion 110 can include a notch 111 formed thereon that receives part of the outer portion 112 thereon, which helps to further secure the outer portion 112 and the inner portion 110 together. FIG. 20 shows another embodiment of an inner portion 110 of an arm 70 without the outer portion 112 positioned thereon, and FIGS. 21 and 22 show the arm 70 of FIG. 20 with the outer portion 112 thereon. As can be see, in this embodiment the inner portion 110 has a plurality of holes/openings 117 extending therethrough, in the horizontal direction during normal operation of the nozzle 10, that are filled with the outer portion 112 which is positioned on both sides of the inner portion 110 to ensure the outer portions 112 is secured retained in place, as shown in FIG. 22. In addition, in this embodiment the inner portion 110 includes a groove 119 extending thereabout which is filled with the outer portion 112, which helps to further secure the outer portion 112 and the inner portion 110 together.

FIG. 23 shows another embodiment of an inner portion 110 of an arm 70 without the outer portion 112 positioned thereon, and FIGS. 24 and 25 show the arm 70 of FIG. 23 with the outer portion 112 thereon. As can be see, in this embodiment the inner portion 110 has a plurality of holes/openings 117 extending therethrough, in the vertical direction during normal operation of the nozzle 10, that are filled with the outer portion 112 which is positioned on both sides of the inner portion 110 to ensure the outer portion 112 is secured retained in place. The embodiment of FIGS. 23-26 also has a groove 119, in which the holes/openings 117 are positioned.

FIG. 26 shows another embodiment of an inner portion 110 of an arm 70 without the outer portion 112 positioned thereon, and FIGS. 27 and 28 show the arm 70 of FIG. 26 with the outer portion 112 thereon. As can be see, in this embodiment the inner portion 110 has a plurality of holes/openings 117 extending therethrough in the vertical direction during normal operation of the nozzle 10. The holes/openings 117 are filled with the outer portion 112 which is positioned on both sides of the inner portion 110 to ensure the outer portions 112 is secured retained in place.

In this manner the outer surfaces provided by the outer portion 112 (which can define the upper 113 and lower 115 surfaces of the associated arm 70) can provide sealing engagement with the nozzle body 12, can reduce water flowing between the sealed surfaces to avoid leakage of water or other dispensed fluid, provide smooth, rattle-free operation of the actuator 78, reduce areas of small restriction and sharp transitions to improve flow performance, accommodate manufacturing tolerances, and accommodate wide temperature ranges.

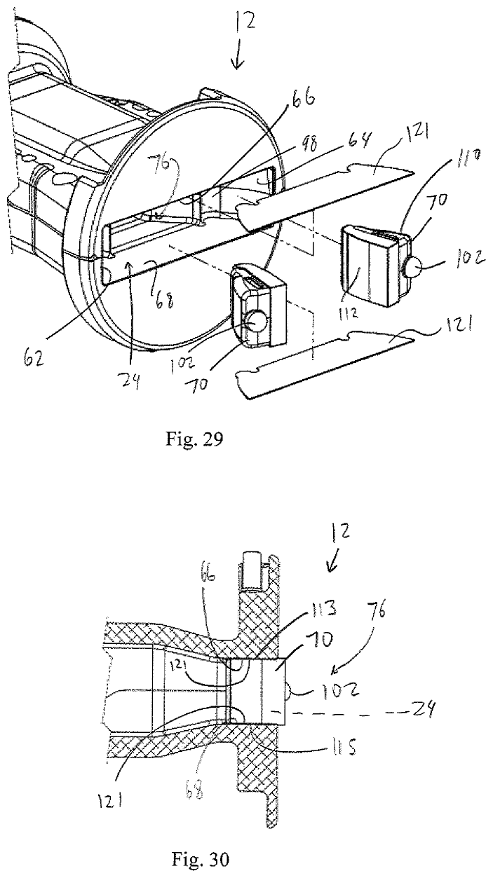

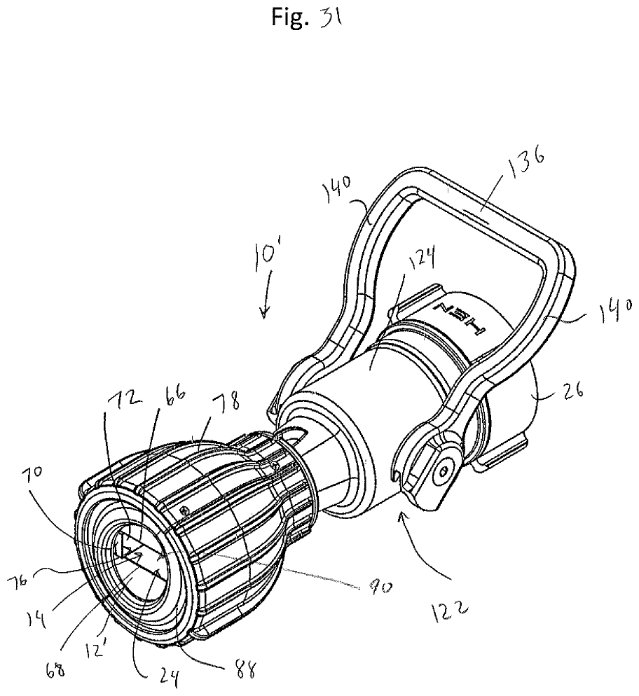

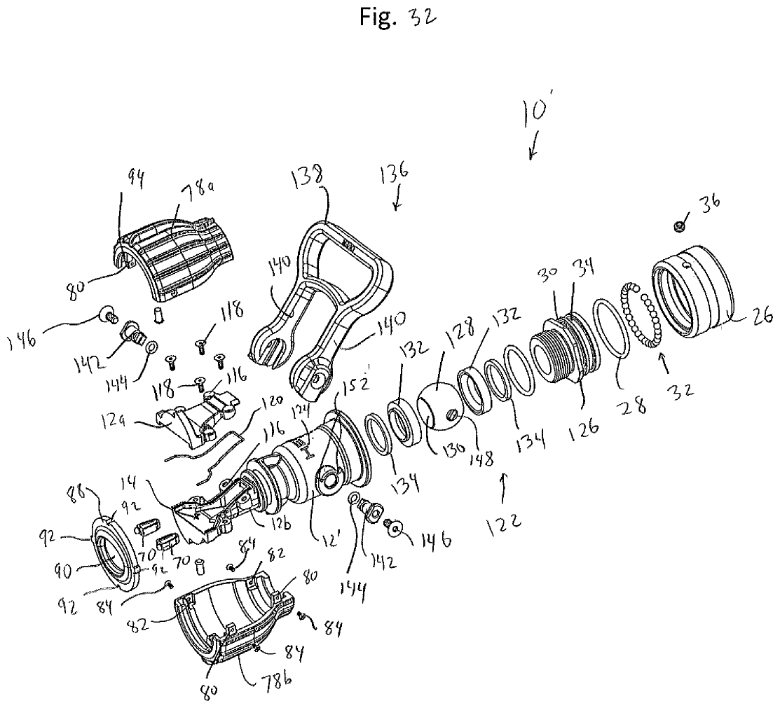

In another embodiment, as shown in FIGS. 29 and 30, a pair of sealing sheets 121, which can be made of the same materials as the outer portions 112 as outlined above or other suitable materials, are positioned on, adjacent to and/or in contact with the upper 66 and/or bottom 68 walls of the modulation section 24. The sealing sheets 121 can be configured cover at least those portions of the upper 66 and/or bottom 68 walls engaged by the upper 113 and lower 115 surfaces, respectively, of the arms 70 across the full range of motion of the arms 70 (e.g. surface 73 of FIG. 17). If desired, rather than utilizing a single sealing sheet 121 across the entire upper 66 and/or bottom 68 walls, each sealing sheet 121 can be divided into two sub-portions (not shown) and/or extend along across surfaces that will be engaged by the arms 70 across their full range of motion. The sealing sheets 121 can be attached to the upper 66/lower 68 walls by a variety of methods, including using adhesives or being molded in place. In this case the arms 70 may not necessarily have the outer portions 112 thereon, but can if desired.

As noted above, the face plate 88 can include the engagement surface 104 which can be a relatively complicated surface with complex and varying geometry, and the face plate 88 can thus be a fairly complicated component to manufacture. Accordingly, as shown in FIG. 2, the face plate 88 can be a component that is made separately from the nozzle body 12 and/or actuator 78, and coupled thereto. In the illustrated embodiment, as outlined above, the face plate 88 has a generally circular outer perimeter that is received in the groove 94 in the shell portions 78a, 78b, and trapped therebetween.

The face plate 88 can thus be made of a separate piece of material that is not integral with and/or is not unitary with and/or not seamlessly joined to the nozzle body 12 and/or shell 78. This enables the face plate 88 to be separately manufactured, such as by 3-D printing, CNC machining, cast molding, investment casting, stamping, etc. Some of these manufacturing processes may be expensive and/or slow, due to the high precision required. However, the nozzle body 12 and/or shell 78 may not need to be manufactured with such high precision, although if desired those components can also be made of the same manufacturing processes identified above for the face plate 88. Thus, by making the face plate 88 separately from the nozzle body 12 and/or shell 78, lower cost and/or faster manufacturing processes can be utilized to form the nozzle body 12 and/or shell 78 than would otherwise be required if the face plate 88 were integrally made with the nozzle body 12 and/or shell 78.

In addition, by making the face plate 88 of a separate piece of material than the nozzle body 12 and/or shell 78, the face plate 88 can be made of a different type of material (such as metal) as compared to the nozzle body 12 and/or shell 78. This enables the face plate 88, for example, to be made of a material that is more precisely machinable and/or retains its precise shape (e.g. is harder, tougher, more heat resistant, etc.), as compared to materials of the nozzle body 12 and/or shell 78 which may be made of materials that can be selected to optimize other properties. The face plate 88 can include, and at its outer perimeter be defined by, the outer face 106, for ease of manufacturing and assembly. In certain other cases the face plate 88 can include a cup-shaped shell extending around the outer perimeter thereof to be coupled to the shell 78 and/or include other portions of the outer shell 78 coupled thereto.

With reference to FIGS. 2, 3 and 5, the nozzle body 12 can include a first nozzle body portion 12a and a second nozzle body portion 12b that are separate components/separate pieces material that can be joined together along a joint line 114 (FIG. 5) extending, in one case, generally around at least part of the perimeter of the nozzle body 12 in top view. In the illustrated embodiment, the first nozzle body portion 12a extends less than an entire length of the nozzle body 12/flow path 14, and the second nozzle body portion 12b extends an entire length of the nozzle body 12/flow path 14.

In the illustrated embodiment and with reference to FIG. 5, the nozzle body portions 12a, 12b are asymmetrical with regard to centerline 71, and joint line 114 is asymmetrical along a length of the nozzle body 12. In particular, a thickness of each nozzle body portion 12a, 12b varies in a radial direction (perpendicular to the flow direction) along the length of at least part of each nozzle body portion 12a, 12b, and the joint line 114 varies in the radial (thickness) direction along the (axial) length of the nozzle 10.

In the illustrated embodiment, each nozzle body portion 12a, 12b has about an equal thickness at the distal end of each nozzle body portion 12a, 12b (at the nozzle outlet 76) and thus the joint line 114 is located at the center of the thickness of nozzle body 12 at the distal end thereof. The first 12a and second 12b nozzle body portions can, in one case, have an equal thickness for the entire modulation section 24. Thus the first 12a and second 12b nozzle body portions can be symmetrical in the modulation section 24, in one case for ease of manufacturing (to avoid unnecessarily thin end portions which may be prone to breakage) or assembly (to provide sufficiently stiff/strong area for connection). Beginning at the inlet 24a of the modulation section 24/outlet 22b of the hybrid section 22, moving upstream, the first nozzle body portion 12a extends an entire length of the hybrid section 22, and part of the length of the transition section 20. The first nozzle body portion 12a thereby tapers (linearly, in the illustrated embodiment) upwardly to a reduced thickness at its (upstream) end in the transition section 20, and the joint line 114 thus extends linearly upwardly in the arrangement shown in FIGS. 2, 3 and 5. In this particular embodiment, the second nozzle body section 12b defines the entirety of the inlet 20a of the transition section 20, and the entirety of the converging section 18 and the inlet section 16.

With reference to FIGS. 2 and 3 each nozzle body portion 12a, 12b can include an radially outwardly-extending boss 116 with an opening formed therethrough that is aligned with a boss 116/opening of the other nozzle body portion 12a, 12b. Each boss 116 is configured to receive a fastener 118 therethrough in the thickness/tangential direction to secure the nozzle body portions 12a, 12b together, and a gasket 120 can be positioned between the nozzle body portions 12a, 12b to ensure a fluid-tight coupling therebetween. The nozzle body portions 12a, 12b can be coupled together by other coupling devices, as desired, such as mechanical coupling device including clamps, rivets, cam-over couplers, etc.

In the illustrated embodiment, the first nozzle body portion 12a extends the entire length of, and at least partially defines, the transition section 20, the hybrid section 22 and the modulation section 24, and terminates in the transition section 20. Thus the first nozzle body portion 12a may define the entire top walls 58, 66, and at least part of the first 54 and second 56 side walls of the hybrid section 22 and at least part of the outer walls 62, 64 of the modulation section 24. The first nozzle body portion 12a may also define at least part of the top wall 50 of the transition section 20, and at least part of the first 46 and second 48 side walls of the transition section 20. Conversely, the second nozzle body portion 12b, in the illustrated embodiment extends the entire length of, and at least partially defines, the entire nozzle body 12, including the inlet section 16, the converging section 18, the transition section 20, the hybrid section 22 and the modulation section 24. Thus the second nozzle body portion 12b may define the entire bottom walls 44, 52, 60 and 68 of the nozzle body 12. The second nozzle body portion 12b may also define the entire first 38 and second 40 side walls of the converging section 18, and the entire top wall 42 of the converging section 18. The second nozzle body portion 12b may define at least part of the first 46 and second 48 side walls of the transition section 20, the first 54 and second 56 side walls of the hybrid section 22, and the outer walls 62, 64 of the modulation section 24. The second nozzle body portion 12b may also define the wall(s) of the inlet section 16.

At least part of the upper surface of the flow path 14 is thereby defined by the first nozzle body portion 12a and the lower surface of the flow path 14 is defined by the second nozzle body portion 12b. The first 12a and second 12b nozzle body portions may therefore, when coupled together, define an entirety of the flow path 14, including the inlet section 16, the converging section 18, the transition section 20, the hybrid section 22 and the modulation section 24.

The flow path 14/nozzle body 12 can be a relatively complex component/surface to manufacture. In particular, when one or more section has a converging cross sectional area and a diverging perimeter (such as in the hybrid section 22 in one case), or vice versa, the manufacturing of that section may be difficult and/or expensive under existing manufacturing methods, and for example not manufacturable by current machining methods and equipment. Accordingly, by providing the separable first 12a and second 12b nozzle body portions, the flow path 14/nozzle body 12, and in particular the hybrid section 22, can be made separately and then joined together. In some cases, the first nozzle body portion 12a may terminate at the inlet 22a of the hybrid section 22/outlet 20b of the transition section 20, but in the illustrated embodiment the first nozzle body portion 12a continues upstream past the inlet 22a of the hybrid section 22, extending at least partially into the transition section 20 to provide a more secure and easier connection at the relatively flat surface of the transition section 20.

By making the first 12a and second 12b nozzle body sections separately, greater and/or full access is provided to the interior surfaces/flow path 14 such that the nozzle body portions 12a, 12b flow path 14 can in one case be made by machining. In contrast, when a section of the nozzle body 12 does not have a converging cross sectional area and a diverging perimeter, or vice versa, such as the transition section 20, converging section 18 and/or inlet section 16 in one case, those sections may have simpler geometries, and thus be easier to manufacture. In that case, the portions of the nozzle body 12 having or defining those sections can be made of a one-piece, unitary integral and seamless component, such as the second nozzle body portion 12b. Thus the particular junction provided between the first 12a and second 12b nozzle body sections can provide the advantages outlined above.

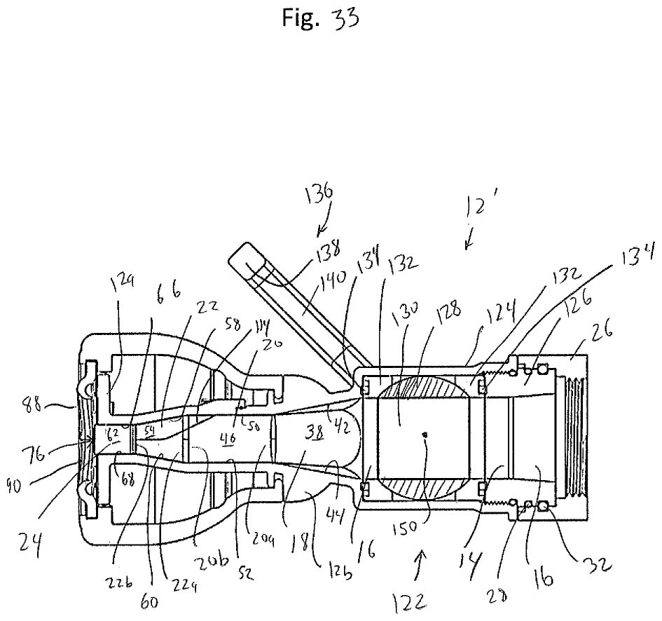

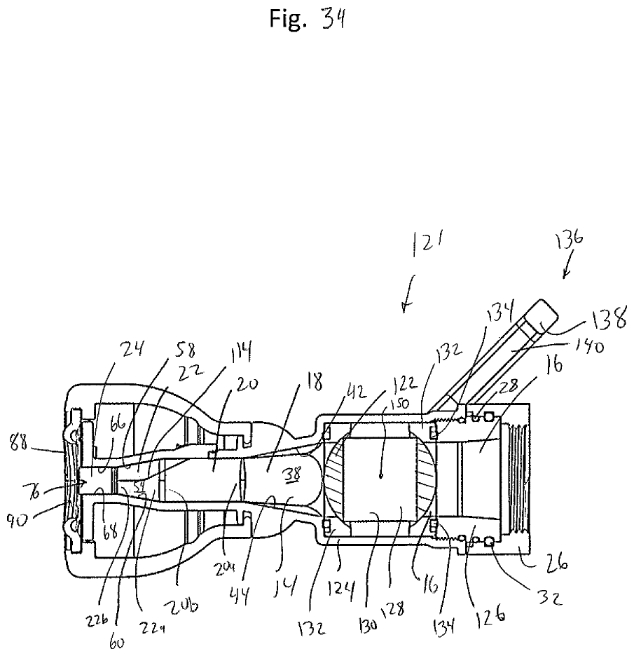

With reference to FIGS. 31-34, in one embodiment the nozzle 10 can include an integrated shutoff valve 122 coupled to the nozzle body 12 and in fluid communication with the flow path 14. The valve 122 is movable between an open position wherein the valve 122 allows fluid to flow therethrough and a closed position wherein the valve 122 blocks fluid from flowing therethrough. In the illustrated embodiment the shutoff valve 122 is positioned in a shutoff valve nozzle body section 124 that is coupled to the main body section (which can include the remaining sections 16, 18, 20, 22, 24 or other downstream components of the nozzle 10). As best shown in FIGS. 33 and 34, the shutoff valve nozzle body section 124 is, in one case integrally/seamlessly formed with as a unitary body with the main body section.

The flow path 14 in the shutoff valve nozzle body section 124 can have a generally circular cross section. A threaded connector 126 is attachable to an upstream end of the shutoff valve nozzle body section 124 and traps/positions the shutoff valve 122 in the nozzle body 12. The threaded connector 126 can define the inlet section 16 that is coupled to the fitting 26.

In the illustrated embodiment the shutoff valve 122 includes or takes the form of a ball valve including a spherical or at least partially spherical ball 128 with an opening 130 extending therethrough. A pair of seals 132, with spherically or generally spherical inner surfaces, are positioned on either side of the ball 128 to sealingly engage the ball 128. Each seal 132 is positioned adjacent to an associated retaining ring 134 to position and retain the seals 132 in place.

When the shutoff valve 122 is in the open position, as shown in FIG. 33, the opening 130 is parallel with, and/or aligned with the flow path 14 and/or in fluid communication with the flow path 14 such that fluid can flow therethrough. In contrast, when the shutoff valve 122 is in the closed position, as shown in FIG. 34, the opening 130 is not aligned with/parallel with the flow path 14, and in particular can be oriented perpendicular to the flow path 14 and/or fluidly isolated from the flow path 14, so that fluid cannot flow therethrough. The shutoff valve 122 can be positioned upstream of the converging section 18, the transition section 20, the hybrid section 22 and the modulation sections 24, such that when the shutoff valve 122 is closed fluid does not flow through the nozzle 10.

The nozzle 10/shutoff valve 122 can include a valve actuator 136 that is manually operable to move the valve 122 between the open and the closed positions. The valve actuator 136 includes a gripping arm 138 extending generally radially, transverse to an axis/length of the nozzle body 12/flow path 14. The valve actuator 136 includes two legs 140, each leg 140 extending from an opposing end of the gripping arm 138 to opposite outer locations on the nozzle body 12/shutoff valve nozzle body section 124. Each leg 140 of the valve actuator 136 is coupled to an associated stem 142 that extends through an opening in the shutoff valve nozzle body section 124. A seal 144 is positioned about each stem 142 to ensure the stem 142 passes through the shutoff valve nozzle body section 124 in a sealed manner. Each leg 140 of the valve actuator can be coupled to the associated stem 142 by a fastener 146.

Each stem 142 rotationally engages and/or is rotationally coupled to the ball 128, at a centerline of the ball 128, which defines an axis of rotation for the ball 128/actuator 136. In the illustrated embodiment, a distal eccentric end of each stem 142 is received in a correspondingly sized and shaped recess 148 in the ball 128. In this manner the valve actuator 136 is pivotable about an axis 150 extending through the valve 122 and through the flow path 14 to thereby move the valve 122 between the open and closed positions. The actuator 136 can move between a forwardly-inclined position (relative to the flow of fluid therethrough), shown in FIG. 33, where the shutoff valve 122 is open, and a rearwardly-inclined position, as shown in FIG. 34, where the shutoff valve 122 is closed. The valve actuator 136 may move about ninety degrees when moving the valve 122 between the open and closed positions, and the nozzle body 12 may include a pair of stops 152 that engage corresponding stops (not shown) on the valve actuator 136 to limit the pivoting motion of the valve actuator 136. Providing a shutoff valve 122 that is integrally formed within the nozzle body 12 provides an nozzle 10 that is easy to operate, reduces leaks, and provides reliable operation.

Having described the invention in detail and by reference to certain embodiments thereof, it will be apparent that modifications and variations are possible without departing from the scope of the invention which is defined in the appended claims.

What is claimed is:

1. A nozzle comprising:
a nozzle body including a flow path therein;
a face plate coupled to or positioned in the nozzle body and including an engagement surface; and
an arm coupled to or positioned in the nozzle body, the arm including an engagement surface engaging the engagement surface of the face plate, wherein at least one of the engagement surface of the face plate or the engagement surface of the arm has at least part of a spherical surface, wherein the face plate and the arm are configured such that relative rotation between the face plate and the nozzle body causes at least part of the arm to move toward or away from a center of the flow path.

2. The nozzle of claim 1 wherein the other one of the engagement surface of the face plate or the engagement surface of the arm includes a groove sized and positioned to closely receive the at least part of a spherical surface therein, wherein the groove has at least part of a circular shape in cross section.

3. The nozzle of claim 1 wherein the at least part of a spherical surface is a hemispherical surface.

4. The nozzle of claim 1 wherein the arm includes a base portion that is closely received in a recess of the nozzle body, and wherein the base portion and the recess have corresponding shapes configured as a portion of a cylinder.

5. The nozzle of claim 1 wherein the engagement surface of the face plate extends generally around at least part of a perimeter of the face plate.

6. (canceled)

7. The nozzle of claim 1 wherein the engagement surface of the face plate extends in a path defining at least part of an oval or ellipse.

8. The nozzle of claim 1 further including an actuator coupled to the nozzle body, wherein the actuator is configured to be manually rotated relative to the nozzle body to cause relative rotation between the face plate and the arm, which in turn causes the at least part of the arm to move toward or away from the center of the flow path.

9. The nozzle of claim 1 wherein the arm is pivotable between a retracted position wherein a distal end of the arm is positioned relatively far from the center of the flow path, and an extended position wherein a distal end of the arm is positioned relatively close to the center of the flow path.

10. (canceled)

11. (canceled)

12. The nozzle of claim 9 wherein the engagement surface of the arm is a hemispherical protrusion and is located at or adjacent to the distal end of the arm.

13. (canceled)

14. The nozzle of claim 1 wherein the at least part of a spherical surface is a spherical ball that is rotatably coupled to the associated one of the face plate or the arm.

15. The nozzle of claim 1 wherein the arm includes an inner portion made of a relatively stiff material, and an outer portion position on each side of the inner portion made of a relatively soft material.

16. The nozzle of claim 15 wherein the inner portion has at least one hole extending therethrough, and wherein the outer portion extends entirely through the hole to help secure the outer portion to the inner portion.

17. The nozzle of claim 1 wherein the nozzle body including a sealing sheet positioned therein and configured to sealingly engage the arm across a range of motion of the arm.

18. (canceled)

19. (canceled)

20. The nozzle of claim 1 further comprising a supplemental arm coupled to the nozzle body, the supplemental arm including an engagement surface having a complementary shape to the engagement surface of the face plate, wherein the face plate and the supplemental arm are configured such that relative rotation between the face plate and the supplemental arm causes at least part of the supplemental arm to move toward or away from the center of the flow path.

21. (canceled)

22. The nozzle of claim 1 wherein the nozzle is configured such that fluid is configured to flow through the flow path in a flow direction, wherein the flow path has a first flow path section that converges with regard to cross sectional surface area along the flow direction, and a second flow path section in fluid communication with the first flow path section, wherein the second flow path section has a cross sectional area that decreases or remains constant along the flow direction, and perimeter length that increases along the flow direction.

23. The nozzle of claim 1 wherein the face plate is a separate piece of material relative to the nozzle body, and wherein the engagement surface of the face plate extends in a path defining an eccentric shape.

24. (canceled)

25. The nozzle of claim 1 wherein the nozzle body includes a first nozzle body portion and a second nozzle body portion that are separate pieces of material, the flow path having a first flow path section having a cross sectional area that decreases along the flow direction and a second flow path section in fluid communication with the first flow path section, wherein the second flow path section has a cross sectional area that decreases or remains constant along the flow direction and a perimeter length that increases along the flow direction, wherein at least part of the second flow path section is defined by at least part of the first nozzle body portion and at least part of the second nozzle body portion.

26. (canceled)

27. The nozzle of claim 1 wherein an entirety of the flow path has a cross sectional area that decreases or remains constant in the flow direction from an inlet to an outlet thereof.

28. A nozzle comprising:
a nozzle body including a flow path therein;
a face plate coupled or positioned in to the nozzle body and including an engagement surface; and
a first arm and a second arm each coupled or positioned in the nozzle body, the first and second arms each including an at least partially spherical protrusion engaging the engagement surface of the face plate, wherein the face plate and the first and second arms are configured such that relative rotation between the face plate and the first and second arms causes a distal end of the first and second arms to move toward or away from a center of the flow path.

29. A nozzle comprising:
a nozzle body including a flow path therein;
a face plate coupled to the nozzle body and including an engagement surface, wherein the face plate is a separate piece of material relative to the nozzle body; and
an arm coupled to the nozzle body and engaging the engagement surface of the face plate such that relative rotation between the face plate and the nozzle body causes at least part of the arm to move toward or away from a center of the flow path.

30. The nozzle of claim 29 wherein the engagement surface extends in a path defining at an eccentric surface.

31. (canceled)

32. (canceled)

33. The nozzle of claim 30 wherein the engagement surface extends in more than one plane.

34. The nozzle of claim 29 wherein the engagement surface is at least one of a groove or a protrusion.

35. (canceled)

36. The nozzle of claim 29 further including an actuator coupled to the nozzle body, wherein the actuator is configured to be manually rotated relative to the nozzle body to cause relative rotation between the face plate and the arm, to in turn cause at least part of the arm to move toward or away from the center of the flow path.

37.-41. (canceled)

42. The nozzle of claim 29 wherein the arm includes a protrusion with at least part of a spherical surface and wherein the engagement surface is a groove sized to closely receive the protrusion therein.

43.-97. (canceled)
